(19) United States
(12) Patent Application Publication
(10) Pub. No.: US 2012/0062623 A1
(43) Pub. Date: Mar. 15, 2012

(54) ORGANIC LIGHT EMITTING DISPLAY AND METHOD OF DRIVING THE SAME

(76) Inventors: Do-Ik KIM, Yongin-city (KR); Jae-Woo Ryu, Yongin-city (KR); Jung-Keun Ahn, Yongin-city (KR)

(21) Appl. No.: 13/170,719

(22) Filed: Jun. 28, 2011

(30) Foreign Application Priority Data
Sep. 14, 2010 (KR) 10-2010-0089944

(51) Int. Cl. G09G 3/32; G09G 5/10

(52) U.S. Cl. 345/691; 345/77

(57) ABSTRACT

A method of driving an organic light emitting display in which a frame is divided into a plurality of sub frames, includes: storing a plurality of bit change values corresponding to emission times in a plurality of lookup tables; selecting one of the lookup tables from among the plurality of lookup tables; measuring and storing emission times of pixels included in the organic light emitting display; extracting one of the bit change values from the selected lookup table corresponding to the emission time of one of the pixels when first data to be supplied to the one of the pixels is input; and changing a bit value of the first data to generate second data to be supplied to the one of the pixels utilizing the extracted bit change value.

### CROSS-REFERENCE TO RELATED APPLICATION

This application claims priority to and the benefit of Korean Patent Application No. 10-2010-0089944, filed on Sep. 14, 2010, in the Korean Intellectual Property Office, the entire content of which is incorporated herein by reference.

### BACKGROUND

1. Field

The following description relates to an organic light emitting display and a method of driving the same, and more particularly, to an organic light emitting display for displaying an image with more uniform brightness and a method of driving the same.

2. Description of Related Art

Recently, various flat panel displays (FPDs) having reduced weight and volume when compared to cathode ray tubes (CRT) have been developed. These FPDs include liquid crystal displays (LCDs), field emission displays (FEDs), plasma display panels (PDPs), and organic light emitting displays, among others.

Among the FPDs, the organic light emitting display displays an image using organic light emitting diodes (OLEDs) that generate light by the re-combination of electrons and holes. The organic light emitting display has fast response times and is driven with low power consumption.

FIG. 1 shows a circuit diagram illustrating a pixel of an existing OLED.

Referring to FIG. 1, a pixel 4 of an organic light emitting display includes an organic light emitting diode OLED and a pixel circuit 2 coupled to a data line Dm and a scan line Sn to control the OLED.

An anode electrode of the OLED is coupled to the pixel circuit 2 and a cathode electrode of the OLED is coupled to a second power source ELVSS. The OLED emits light with predetermined brightness in response to current supplied from the pixel circuit 2.

The pixel circuit 2 controls an amount of current supplied to the OLED in response to a data signal supplied to the data line Dm when a scan signal is supplied to the scan line Sn. Therefore, the pixel circuit 2 includes a second transistor M2 coupled between a first power source ELVDD and the OLED, a first transistor M1 coupled between the second transistor M2 and the data line Dm, and having a gate electrode coupled to the scan line Sn, and a storage capacitor C coupled between a gate electrode of the second transistor M2 and a first electrode of the second transistor M2.

The gate electrode of the first transistor M1 is coupled to the scan line Sn, and a first electrode of the first transistor M1 is coupled to the data line Dm. A second electrode of the first transistor M1 is coupled to one terminal of the storage capacitor C. Here, the first electrode is one of a source electrode or a drain electrode, and the second electrode is the other one of the source electrode or the drain electrode. For example, when the first electrode is the source electrode, the second electrode is the drain electrode. The first transistor M1 is turned on when the scan signal is supplied from the scan line Sn, and supplies the data signal supplied from the data line Dm to the storage capacitor C. At this time, the storage capacitor C charges a voltage corresponding to the data signal.

The gate electrode of the second transistor M2 is coupled to an electrode of the storage capacitor C and the first electrode of the second transistor M2 is coupled to the other electrode of the storage capacitor C and the first power source ELVDD. A second electrode of the second transistor M2 is coupled to the anode electrode of the OLED. The second transistor M2 controls the amount of current supplied from the first power source ELVDD to the second power source ELVSS via the OLED in response to the voltage stored in the storage capacitor C. At this time, the OLED generates light corresponding to the amount of current supplied from the second transistor M2.

The pixel 4 of the organic light emitting display displays an image with predetermined brightness while repeating the above-described processes. On the other hand, in digital driving where the second transistor M2 operates as a switch, the first power source ELVDD and the second power source ELVSS are supplied to the OLED so that the OLED emits light by electrostatic voltage driving. Digital driving has an advantage of displaying an image regardless of non-uniformity of a threshold voltage of the second transistor M2.

However, in digital driving, since an electrostatic voltage is applied to the OLED, the OLED deteriorates faster, so that an image with uniform brightness may not be displayed.

### SUMMARY OF THE INVENTION

Accordingly, embodiments of the present invention provide an organic light emitting display for displaying an image with more uniform brightness and a method of driving the same.

According to an embodiment of the present invention, there is provided a method of driving an organic light emitting display in which a frame is divided into a plurality of sub frames, including: storing a plurality of bit change values corresponding to emission times in a plurality of lookup tables; selecting one of the lookup tables from among the plurality of lookup tables; measuring and storing emission times of pixels included in the organic light emitting display; extracting one of the bit change values from the selected lookup table corresponding to the emission time of one of the pixels when first data to be supplied to the one of the pixels is input; and changing a bit value of the first data to generate second data to be supplied to the one of the pixels utilizing the extracted bit change value.

Selecting the one of the lookup tables may include: measuring a brightness reduction ratio corresponding to emission times; and selecting the one of the lookup tables from among the plurality of lookup tables corresponding to the measured brightness reduction ratio. The measuring of the emission times of the pixels may include adding the first data. The bit change values may be bit values to be added to the first data corresponding to the emission times of the pixels. In the first data, the bit values may correspond to partial periods of the frame. The bit values of the first data may be changed to generate second data, so that a use time during the frame increases.

According to another embodiment of the present invention, there is provided an organic light emitting display, including: a scan driver for supplying scan signals to scan lines during scan periods of a plurality of sub fields included in a frame; a data driver for generating data signals using second data; pixels for emitting light corresponding to the data signals; a deterioration compensating unit including a plurality of lookup tables in which bit change values corresponding to emission times are stored; and a timing controller for adding first data supplied from the outside to generate accumulated data, and for generating the second data corresponding to the accumulated data and one of the bit change values stored in a corresponding one of the lookup tables from among the plurality of lookup tables.

The deterioration compensating unit may further include a selector for coupling a selected lookup table from among the plurality of lookup tables to the timing controller. The timing controller may be configured to supply a deterioration control signal to the selector for selecting one of the lookup tables corresponding to a brightness reduction ratio based on the emission times of the pixels. The timing controller may include: a controller for calculating the accumulated data; and a memory for storing the accumulated data. The controller may be configured to extract the emission time of one of the pixels utilizing the accumulated data of the one of the pixels when the first data to be supplied to the one of the pixels is input, and to extract one of the bit change values from a corresponding one of the lookup tables corresponding to the extracted emission time to generate the second data. The controller may further be configured to add the one of the bit change values to the first data to generate the second data.

In the organic light emitting display and the method of driving the same, a bit value of first data is changed to generate second data so that deterioration of OLEDs may be compensated for. The data signals are generated using the second data to compensate for the deterioration of the OLEDs. In addition, according to embodiments of the present invention, a plurality of lookup tables may be previously stored, and one of the stored lookup tables may be selected to generate the second data. In this case, a process for generating bit change values corresponding to deterioration of the OLEDs may be omitted.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a circuit diagram illustrating a pixel of a conventional organic light emitting display;

FIG. 2 is a view illustrating a brightness characteristic of an organic light emitting diode (OLED);

FIG. 3 is a view illustrating brightness corresponding to an emission time of a pixel;

FIGS. 4A and 4B illustrate a deterioration compensating principle according to an embodiment of the present invention;

FIG. 5 is a schematic view illustrating an organic light emitting display according to an embodiment of the present invention;

FIG. 6 is a schematic view illustrating a deterioration compensating unit and a timing controller of FIG. 5; and

FIG. 7 is a graph illustrating a brightness characteristic corresponding to process deviation.

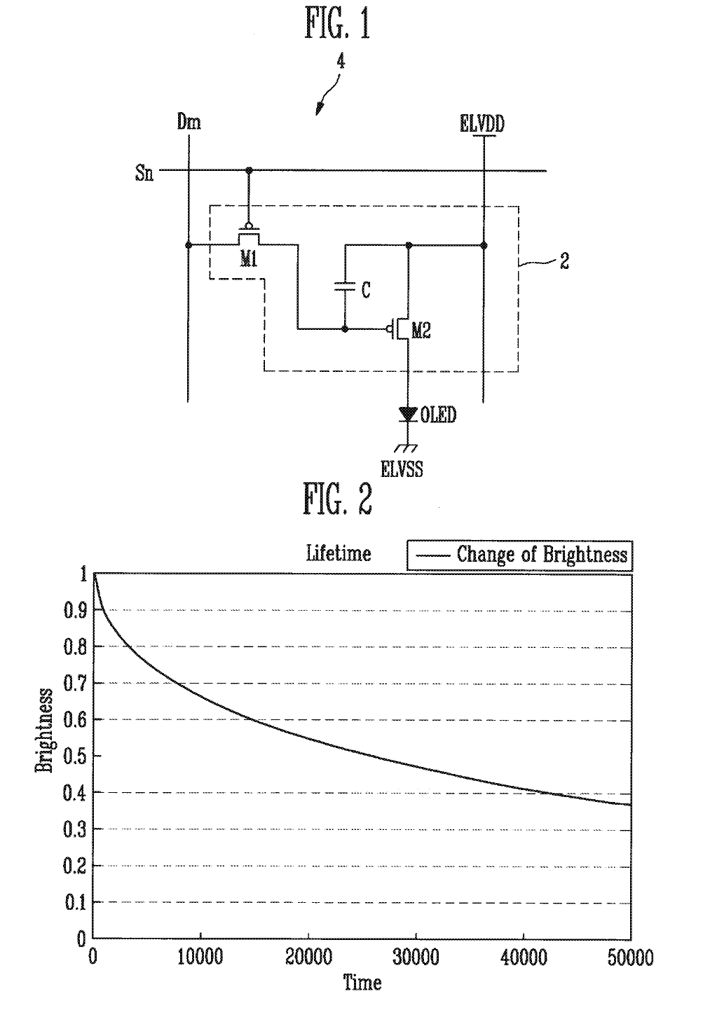

### DETAILED DESCRIPTION

Hereinafter, certain exemplary embodiments according to the present invention will be described with reference to the accompanying drawings. Here, when a first element is described as being coupled to a second element, the first element may either be directly coupled to the second element, or may be indirectly coupled to the second element via one or more additional elements. Further, some of the elements that are not essential to the complete understanding of the invention are omitted for clarity. Also, like reference numerals refer to like elements throughout.

Hereinafter, embodiments of the present invention will be described in detail with reference to FIGS. 2 to 7.

FIG. 2 is a view illustrating a brightness characteristic of an organic light emitting diode (OLED). In FIG. 2, the X axis represents time and the Y axis represents brightness. Here, for the brightness of the Y axis, initial brightness is set or normalized at “1”.

Referring to FIG. 2, an organic light emitting diode (OLED) deteriorates as time goes by in digital driving, so that brightness is reduced. An OLED that emits light for about 50,000 times or hours may emit light with brightness of about 37% in comparison with an initial stage. As described above, when an OLED deteriorates, an image with desired brightness may not be displayed.

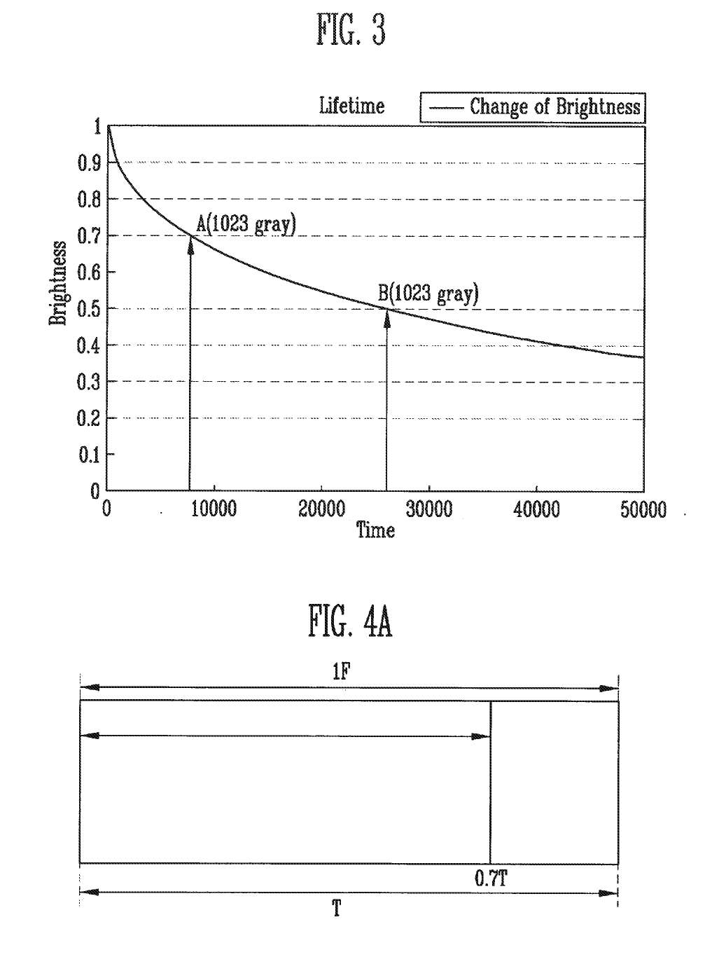

FIG. 3 is a view illustrating brightness corresponding to an emission time of a pixel.

Referring to FIG. 3, a rate of deterioration of the OLED is in proportion to time of use. Therefore, an OLED included in a pixel that emits a larger amount of light deteriorates faster than an OLED included in a pixel that emits a smaller amount of light. For example, when a pixel “B” emits a large amount of light, the pixel “B” has brightness of 0.5 of the initial brightness when a highest gray level (for example, a gray level of 1,023) is realized after a certain time. A pixel “A” that has emitted a smaller amount of light than the pixel “B” may have a brightness of 0.7 of the initial brightness when the highest gray level is realized. As described above, when the pixels “A” and “B” emit light with different brightness, an image with uniform brightness may not be or may be more difficult to be displayed.

According to embodiments of the present invention, a brightness of deteriorated pixels may be gradually increased to compensate for deterioration of the corresponding OLEDs. That is, according to embodiments of the present invention, a bit value of data is controlled so that light with a desired brightness is generated by pixels to compensate for deterioration of a corresponding OLED. Here, since the organic light emitting display according to embodiments of the present invention is driven in digital driving, when a bit value of data is controlled, emission time of one frame can thereby be controlled.

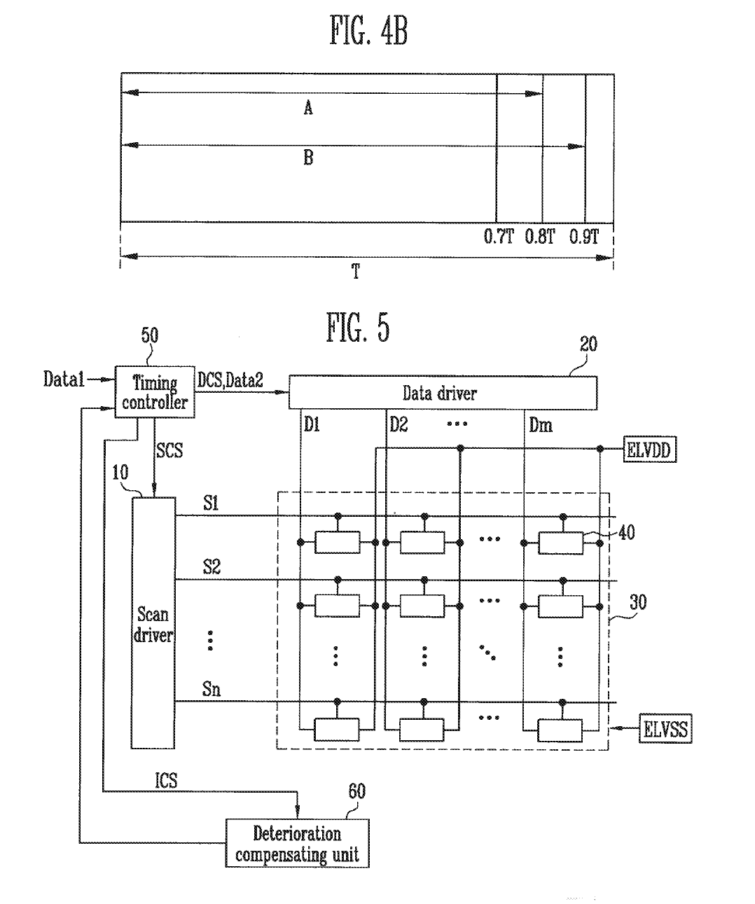

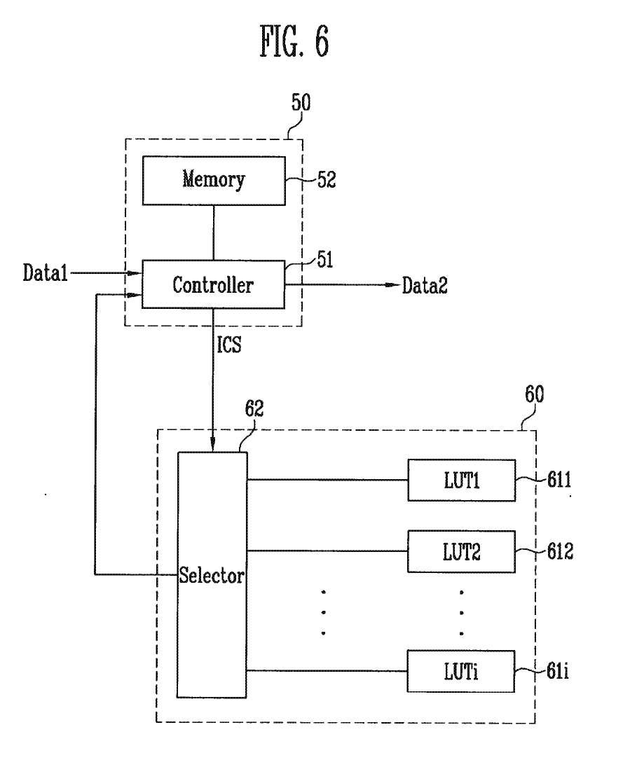

FIGS. 4A and 4B illustrate a deterioration compensating principle according to an embodiment of the present invention.

Referring to FIG. 4A, first, when one frame period is set as T, pixels may emit light during a period of 0.7T in an initial state (e.g., in a state where OLEDs are not deteriorated). That is, when the pixels emit light at a highest gray level in the initial state, light may only be emitted during 70% of the frame period T.

Then, as illustrated in FIG. 4B, emission time of the pixels can be increased corresponding to deterioration of the OLEDs included in the pixels. Then, the deterioration of the OLEDs included in the pixels is compensated for, so that an image with more uniform brightness may be displayed. For example, emission time may be controlled so that light is emitted during a period of 0.8T when the pixel “A” from FIG. 3 emits light at the highest gray level and that light is emitted during a period of 0.9T when the pixel “B” from FIG. 3 emits light at the highest gray level.

In the frame period T, a bit value of the data is changed in order to control the emission time of the pixels. For example, the bit value corresponding to the highest gray level in the initial state may be set as “01111111”. Then, when the bit value is increased to correspond to the deterioration of the OLEDs included in the pixels, as illustrated in FIG. 4B, the emission time of the pixels also increases.

FIG. 5 is a schematic view illustrating an organic light emitting display according to an embodiment of the present invention.

Referring to FIG. 5, the organic light emitting display according to the embodiment of the present invention includes a display panel 30 having a plurality of pixels 40 coupled to scan lines S1 to Sn and data lines D1 to Dm, a scan driver 10 for driving the scan lines S1 to Sn, a data driver 20 for driving the data lines D1 to Dm, a timing controller 50 for controlling the scan driver 10 and the data driver 20, and a deterioration compensating unit 60 for compensating for deterioration of OLEDs included in the pixels 40.

The pixels 40 receive a first power source ELVDD and a second power source ELVSS having a lower voltage then a voltage of the first power source ELVDD from the outside. The pixels 40 generate light with brightness (e.g., a predetermined brightness) by controlling an amount of current that flows from the first power source ELVDD to the second power source ELVSS via the OLEDs in response to data signals.

The scan driver 10 supplies scan signals to the scan lines S1 to Sn in the scan periods of a plurality of sub frames included in one frame. When the scan signals are supplied to the scan lines S1 to Sn, the pixels 40 are selected corresponding to horizontal lines.

The data driver 20 supplies the data signals to the data lines D1 to Dm in synchronization with the scan signals. Here, the data driver 20 may supply data signals such as a first data signal for the pixels 40 to emit light or a second data signal for the pixels 40 to not emit light. Then, during emission periods included in the sub frames, the pixels 40 that receive the first data signal emit light in a predetermined period (e.g., a sub frame period) to display an image with brightness (e.g., a predetermined brightness).

The timing controller 50 generates data driving control signals DCS and scan driving control signals SCS to correspond to synchronizing signals (not shown) supplied from the outside. The data driving control signals DCS generated by the timing controller 50 are supplied to the data driver 20 and the scan driving control signals SCS are supplied to the scan driver 10.

In addition, the timing controller 50 accumulates (or adds) first data Data1 corresponding to the pixels 40 to generate accumulated data and to store the generated accumulated data in a memory (not shown). Here, the accumulated data stored in the memory may include information on emission times of the pixels 40. The timing controller 50 may change a bit of the first data Data1 to generate second data Data2 so that the deterioration of the OLEDs included in the pixels 40 may be compensated for, with reference to the deterioration compensating unit 60 and the accumulated data, and supplies the generated second data Data2 to the data driver 20.

Bit change values corresponding to the emission times of the pixels 40 may be stored in the deterioration compensating unit 60. Here, the bit change value may be a bit value to be changed so that deterioration may be compensated for, based on total emission times. For example, a bit change value of “00000001” may be stored in the deterioration compensating unit 60 to correspond to pixels 40 having a total emission time of 1,000 hours. Here, the timing controller 50 may add this bit change value to the currently input first data Data1 to generate the second data Data2 when the pixels 40 have emitted light for 1,000 hours.

The deterioration compensating unit 60 may include a plurality of lookup tables (hereinafter, referred to as LUTs) in which the bit change values are stored corresponding to brightness characteristics, where one LUT may be selected from among the plurality of LUTs corresponding to a deterioration control signal ICS supplied from the timing controller 50.

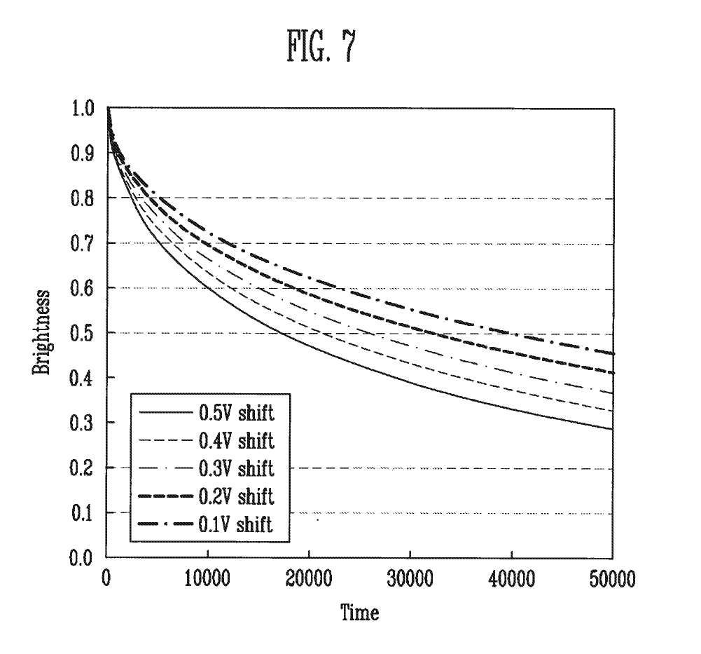

FIG. 6 is a schematic view illustrating a deterioration compensating unit and a timing controller of FIG. 5.

Referring to FIG. 6, a deterioration compensating unit 60 according to an embodiment of the present invention includes a selector 62 and a plurality of LUTs 611, 612, . . . , and 61i.

Bit change values corresponding to the emission times of the pixels 40 are stored in the LUTs 611, 612, ..., and 61 i. Here, the bit change values corresponding to the emission times of the pixels 40 stored in the LUTs 611, 612, . . . , and 61i may be set to vary.

In detail, the brightness reduction ratios of the pixels 40 corresponding to the emission times are set to vary corresponding to process conditions of a display panel. For example, when the resistances of the OLEDs change corresponding to voltages applied to the OLEDs, that is, process conditions, for example, as illustrated in FIG. 7, changes in brightness are set to vary to correspond to the emission times of the pixels 40. Therefore, according to an embodiment of the present invention, the plurality of LUTs 611, 612, . . . , and 61i are provided to correspond to a plurality of process condition changes.

For example, the first LUT 611 may store bit change value or values corresponding to the emission time when the voltages applied to the OLEDs change by 0.1V and the second LUT 612 may store bit change value or values corresponding to the emission time when the voltages applied to the OLEDs change by 0.2V. In addition, the ith LUT 61i may store bit change value or values corresponding to the emission time when the voltages applied to the OLEDs change by, for example, 0.5V.

The selector 62 receives the deterioration control signal ICS from the timing controller 50 and couples one LUT (one of 611 to 61i) from among the plurality of LUTs 611 to 61i to the timing controller 50.

The timing controller 50 according to the embodiment of the present invention includes a controller 51 and a memory 52. Additional features for generating, for example, synchronization signals may further be provided in the timing controller 50. However, for sake of convenience, only the controller 51 and the memory 52 are illustrated in FIG. 6.

The controller 51 adds the first data Data1 supplied from the outside to generate accumulated data and stores the generated accumulated data in the memory 52. The controller 51 generates the second data Data2 using the bit change value or values from a selected LUT (one of WT1 to LUTi) coupled via the selector 62, and supplies the generated second data Data2 to the data driver 20.

In detail, the controller 51 that receives the first data Data1 to be supplied to a specific pixel 40 senses the emission time of the specific pixel 40 with reference to the accumulated data corresponding to the specific pixel 40. The controller 51 extracts the bit change value corresponding to the emission time from the selected LUT (one of LUT1 to LUTi), and adds the bit change value to the first data Data1 to generate the second data Data2 and supplies the generated second data Data2 to the data driver 20.

The controller 51 also generates the deterioration control signal ICS and supplies the generated deterioration control signal ICS to the selector 62. In detail, while the display panel undergoes a processing process, the display panel undergoes an aging process also. During the aging process, the pixels 40 are set in an emission state for predetermined times. In general, during the aging process, changes in the brightness components of the pixels 40 corresponding to the emission times are measured, and the brightness measurements are used for setting the process conditions.

The controller 51 generates the deterioration control signal ICS to correspond to brightness characteristics of the pixels 40 measured during an aging process. In detail, the brightness characteristics (the brightness reduction ratios corresponding to the emission times) of the pixels 40 measured during the aging process is fed back to the controller 51. The controller 51 supplies the deterioration control signal ICS to the selector 62 so that an LUT (one of LUT1 to LUTi) is selected corresponding to the brightness characteristics of the pixels 40 from among the plurality of LUTs LUT1 to LUTi.

The above-described operation processes of the organic light emitting display according to an embodiment of the present invention will now be further described as follows. First, the controller 51 generates the deterioration control signal ICS to correspond to brightness characteristics of the pixels 40 measured during the aging process and supplies the generated deterioration control signal ICS to the selector 62.

Then, the controller 51 adds the first data Data1 to generate accumulated data and stores the generated accumulated data in the memory 52. Then, the controller 51 detects the emission time of a specific pixel from the memory 52 when the first data Data1 corresponding to the specific pixel is input, and extracts a bit change value corresponding to the detected emission time from the deterioration compensating unit 60. The controller 51 changes the bit value of the first data Data1 to generate second data Data2, and supplies the generated second data Data2 to the data driver 20.

The data driver 20 generates a data signal using the second data Data2 and supplies the generated data signal to the specific pixel.

In this case, since the data signal supplied to the specific pixel corresponds to the second data Data2, that is, since the data signal is supplied so that the deterioration of the OLED of the specific pixel is compensated for, an image with desired brightness may be more readily displayed, despite the deterioration of the OLED.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A method of driving an organic light emitting display in which a frame is divided into a plurality of sub frames, comprising:
storing a plurality of bit change values corresponding to emission times in a plurality of lookup tables;
selecting one of the lookup tables from among the plurality of lookup tables;
measuring and storing emission times of pixels included in the organic light emitting display;
extracting one of the bit change values from the selected lookup table corresponding to the emission time of one of the pixels when first data to be supplied to the one of the pixels is input; and
changing a bit value of the first data to generate second data to be supplied to the one of the pixels utilizing the extracted bit change value.

2. The method as claimed in claim 1, wherein selecting the one of the lookup tables comprises:
measuring a brightness reduction ratio corresponding to emission times; and
selecting the one of the lookup tables from among the plurality of lookup tables corresponding to the measured brightness reduction ratio.

3. The method as claimed in claim 1, wherein the measuring of the emission times of the pixels comprises adding the first data.

4. The method as claimed in claim 1, wherein the bit change values are bit values to be added to the first data corresponding to the emission times of the pixels.

5. The method as claimed in claim 1, wherein, in the first data, the bit values correspond to partial periods of the frame.

6. The method as claimed in claim 5, wherein the bit values of the first data are changed to generate second data, so that a use time during the frame increases.

7. An organic light emitting display, comprising:
a scan driver for supplying scan signals to scan lines during scan periods of a plurality of sub fields included in a frame;
a data driver for generating data signals using second data;
pixels for emitting light corresponding to the data signals;
a deterioration compensating unit comprising a plurality of lookup tables in which bit change values corresponding to emission times are stored; and
a timing controller for adding first data supplied from the outside to generate accumulated data, and for generating the second data corresponding to the accumulated data and one of the bit change values stored in a corresponding one of the lookup tables from among the plurality of lookup tables.

8. The organic light emitting display as claimed in claim 7, wherein the deterioration compensating unit further comprises a selector for coupling a selected lookup table from among the plurality of lookup tables to the timing controller.

9. The organic light emitting display as claimed in claim 8, wherein the timing controller is configured to supply a deterioration control signal to the selector for selecting one of the lookup tables corresponding to a brightness reduction ratio based on the emission times of the pixels.

10. The organic light emitting display as claimed in claim 7, wherein the timing controller comprises:
a controller for calculating the accumulated data; and
a memory for storing the accumulated data.

11. The organic light emitting display device as claimed in claim 10, wherein the controller is configured to extract the emission time of one of the pixels utilizing the accumulated data of the one of the pixels when the first data to be supplied to the one of the pixels is input, and to extract one of the bit change values from a corresponding one of the lookup tables corresponding to the extracted emission time to generate the second data.

12. The organic light emitting display device as claimed in claim 11, wherein the controller is further configured to add the one of the bit change values to the first data to generate the second data.
